(19) United States
(12) Patent Application Publication
(10) Pub. No.: US 2015/0261861 A1
(43) Pub. Date: Sep. 17, 2015

(54) Framework for Composing Real-Time Media Using a Declarative Mark-Up Language

(71) Applicant: Futurewei Technologies, Inc., Plano, TX (US)

(72) Inventors: Li Li, Bridgewater, NJ (US); Tao Cai, Shenzhen (CN); Wu Chou, Basking Ridge, NJ (US)

(73) Assignee: Futurewei Technologies, Inc., Plano, TX (US)

(21) Appl. No.: 14/206,273

(22) Filed: Mar. 12, 2014

(51) Int. Cl. G06F 17/30

(52) U.S. Cl. CPC G06F 17/30864; G06F 17/30106; G06F 17/30203

(57) ABSTRACT

In a web client in a network device, a method comprising retrieving a data file written in a declarative mark-up language, wherein the data file contains a description of desired media processing resources for providing a communication session, parsing the data file to determine the desired media processing resources, comparing the desired media processing resources against resources available to the web client on the network device, and mapping the desired media processing resources to the resources available to the web client to generate an executable file, wherein the executable file contains a description for implementing the communication session via the resources available to the web client.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Mark-up languages, such as HyperText Mark-up Language (HTML) 5, are commonly employed for structuring and presenting internet content. Utilizing an application programming interface (API), such as a Javascript (JS) API, with a markup language provides a platform to compose (e.g., mix, transform, transmit, etc.) real-time media. For example, conventional methods for manipulating a real-time media stream based on HTML5 and JS APIs exist, such as HTML5 media API, Stream Processing API, Web Audio API, Mozilla Audio Data API, Media Controller API, Media Capture API, and HTML5 Media Capture HTML5. When combining or composing real-time media using multiple API models, conventional methods may require the web developer to understand multiple API models. Additionally, existing solutions for composing real-time media using multiple API models may add an abstraction layer to the API models to establish a common model. Such solutions may require additional code to be incorporated with the API models which may result in an increase of data size and an increase in processing time. As such, it may be desirable to provide alternative methods for combining multiple APIs with real-time communications to provide a real-time media stream.

### SUMMARY

In one embodiment, the disclosure includes in a web client in a network device, a method comprising retrieving a data file written in a declarative mark-up language, wherein the data file contains a description of desired media processing resources for providing a communication session, parsing the data file to determine the desired media processing resources, comparing the desired media processing resources against resources available to the web client on the network device, and mapping the desired media processing resources to the resources available to the web client to generate an executable file, wherein the executable file contains a description for implementing the communication session via the resources available to the web client.

In another embodiment, the disclosure includes a computer program product comprising computer executable instructions stored on a non-transitory medium that when executed by a processor cause a web client in a network device to perform the following retrieve a data file written in a declarative mark-up language from a memory device, wherein the data file contains a description of desired media processing resources for providing a communication session, parse the data file to determine the desired media processing resources, compare the desired media processing resources against resources available to the web client, and map the desired media processing resources to the resources available to the web client to generate an executable file, wherein the executable file contains a description for implementing the communication session via the resources available to the web client.

In yet another embodiment, the disclosure includes an apparatus comprising a processor, a memory in data communication with the processor, wherein the memory device comprises computer executable instructions that when executed by the processor causes the apparatus to perform the following retrieve a data file written in a declarative mark-up language, wherein the data file contains a description of desired media processing resources for providing a communication session, parse the data file to determine the desired media processing resources, compare the desired media processing resources against resources available to a web client, and map the desired media processing resources to the resources available to the web client to generate an executable file, wherein the executable file contains a description for implementing the communication session via the resources available to the web client.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic view of an embodiment of a client server network.

FIG. 2 is a directed graph of an embodiment of a media processing task.

FIGS. 3-5 are schematic views of embodiments of media processing tasks.

FIG. 6 is a flowchart of an embodiment of a media processing method.

FIG. 7 is a schematic view of an embodiment of a network client.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein is a framework presented for mixing, transforming, and communicating real-time media. The expression “real-time media” is used generally herein to refer to applications which multimedia data may be delivered and/or rendered in about real-time, for example, interactive multimedia or streaming media. In real-time media and/or communications, data may be communicated to/from a user without significant delays. The framework includes a two-level declarative programming language paradigm for composing real-time media in web browsers. The term “composing” or “composition” is used generally herein to refer to the implementation of the framework or the binding of abstract resources with concrete resources (e.g., speaker, microphone, camera, etc.), as will be disclosed herein, to provide real-time media. In a first level, a declarative mark-up language may be employed to define an abstraction of resources and how media streams flow between them without reference to any concrete resources (e.g., speaker, microphone, camera, etc.), such that the first level may be ported to different devices without change. The declarative mark-up language may be referred to herein as a “media composition language” (MCL). Syntax is presented for the MCL. In a second level, a binding mechanism may be employed to bind the abstract resources to one or more concrete resources (e.g., speaker, microphone, camera, etc.) on a device at run-time, such that the resulting MCL file can be executed in a device.

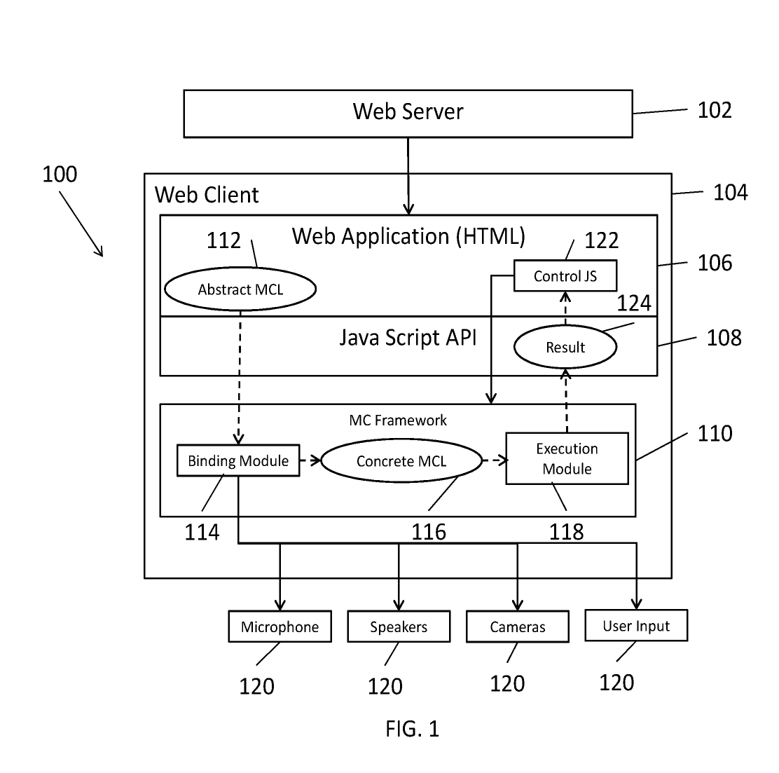

FIG. 1 is a schematic view of an embodiment of a client server network 100. For illustrative purposes, a dash line is shown to represent a data path (i.e., a path associated with the communication of data) and a solid line is shown to represent a control path (i.e., a path associated with the control and/or processing of data) between two or more components of the client server network 100. In an embodiment, the client server network 100 comprises a web server 102 in data communication with a web client or browser 104. Additionally, the web client 104 may be configured to interface with and/or to communicate data with one or more physical or concrete resources 120.

In an embodiment, the web client 104 may comprise a web application 106, a JS API 108, and a media composition (MC) framework 110. The web application 106 may be configured to interface with or to communicate data with the JS API 108 and/or the MC framework 110. The web client 104 may be configured to display media (e.g., via a web page). The web application 106 may be configured to receive (e.g., download or store) an abstract MCL file 112, for example, from the web server 102 which may be linked or inserted inline in a HTML page. Additionally, the web application 106 may comprise a user control JS module 122. As used herein, the term “module” preceded by a descriptor may refer to computer program instructions used to perform the descriptor. For example, a user control JS module may refer to computer program instructions used to provide a JS-based user interface. The computer program instructions may be executed by a general-purpose processor to perform the indicated descriptor or function. Steps sufficient to implement the modules referenced herein are described herein. The JS API 108 may be generally configured to enable JS functions and/or routines. For example, the JS API 108 may comprise a library comprising specifications for routines, data structure, object classes, and variables.

The MC framework 110 may be generally configured to receive an abstract MCL file 112 and to generate a concrete MCL file 116, as will be disclosed herein. The term “abstract MCL” is used generally herein to refer to a MCL file associated with the definitions of abstract resources and how media streams flow between them. The term “concrete MCL” is used herein to generally to refer to a MCL file defining the binding or mapping of abstract resource to concrete resources. For example, the MC framework 110 may be configured to receive an abstract MCL file 112 from the web application 106, to generate a concrete MCL file 116, and to execute the concrete MCL file 116 within the web client 104. Additionally, the MC framework 110 may be configured to communicate data (e.g., a media stream) with one or more concrete resources 120. In an embodiment, the MC framework 110 comprises a binding module 114 and an execution module 118. The binding module 114 may be generally configured to receive an abstract MCL file 112 and to output a concrete MCL file 116. In an embodiment, the binding module 114 binds each of the abstract resources from the abstract MCL file 112 to one or more concrete resources, and thereby generates a binding data portion of the concrete MCL file 116. For example, a concrete resource may be bound to an abstract resource if the concrete resource satisfies all of the constraints (e.g., input constraints and/or output constraints) of the abstract resource. For example, the binding module 114 may search a repository or database of resources available to a network client to determine a suitable concrete resource. Additionally, the binding module 114 may be configured to request consent for use of concrete resources and receive a signal indicating consent in response to the request. A request may be displayed on a video display to a user, and a signal indicating consent may be generated when a user indicates consent using an input/output device. In such an embodiment, the binding module 114 may bind an abstract resource to a concrete resource in response to the signal indicating consent. For example, the signal indicating consent may be a user's selection to select a concrete resource to be bound to an abstract resource. Alternatively, the signal indicating consent may be generated in response to a user's consensus or confirmation, for example, to provide security and/or privacy. Alternatively, any other suitable signals to indicate consent may be employed as would be appreciated by one of ordinary skill in the art upon viewing this disclosure. In an alternative embodiment, any other suitable binding strategy may be employed as would be appreciated by one of ordinary skill in the art upon viewing this disclosure.

In an embodiment, the execution module 118 may be generally configured to receive an executable file (i.e., the concrete MCL file 116) and to execute a result 124 to the web client 104. For example, the execution module 118 may render an expected result (e.g., result 124) on an HTML5 page via the web application 106 and/or the JS API 108. Alternatively, the expected result may be rendered on a HTML5 document object model (DOM), a web application, or any other suitable resource as would be appreciated by one of ordinary skill in the art upon viewing this disclosure. In an embodiment, the execution module 118 may schedule the execution of individual concrete resources and/or the media flow between a plurality of concrete resources. For example, when establishing a call between peers, the execution module 118 may initiate a handshake protocol (e.g., “offer/answer” messages) between the peers to negotiate and/or establish communications. In an alternative embodiment, the any other suitable scheduling strategy may be employed as would be appreciated by one of ordinary skill in the art upon viewing this disclosure.

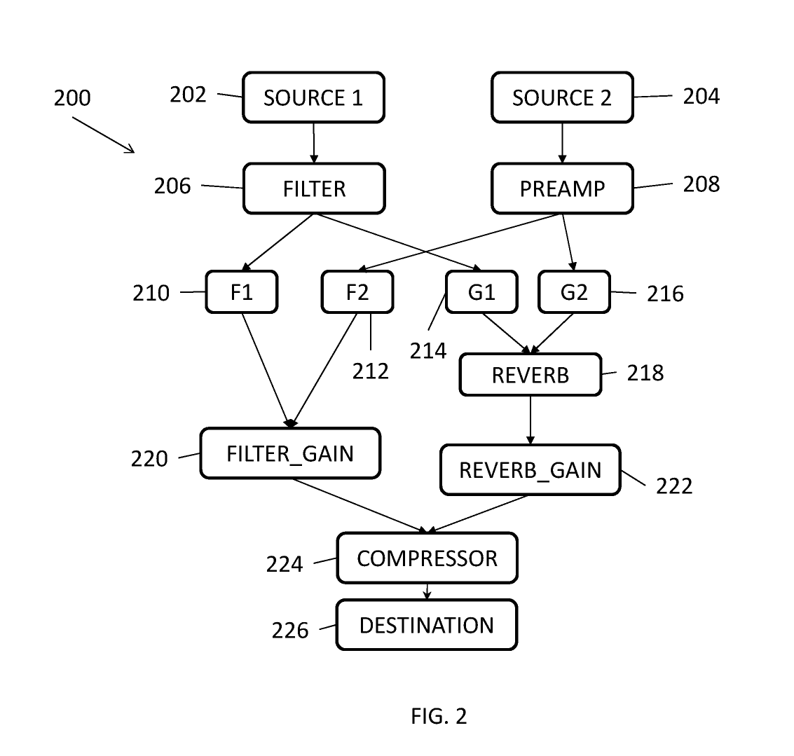

FIG. 2 is a directed graph embodiment of a media processing task 200. A media processing task 200 may generally describe a desired functionality to be implemented, for example, within a network client and/or web client. A directed graph may be employed to illustrate data or media flow between a plurality of resources (e.g., abstract resources) for a media processing task. In such an example, the media processing task 200 is configured to process data from a first source node 202 and/or a second source node 204 and to output the processed data via a destination node 226. For example, the media processing task 200 may be configured such that data flows from the first source node 202 to the destination node 226 via a first filter node 206, a second filter node 210, a filter gain node 220, and a compressor node 224. In parallel, the media processing task 200 may be configured such that data flows from the first source node 202 to the destination node 226 via the first filter node 206, a first gain node 214, a reverb node 218, a reverb gain node 222, and the compressor node 224. Additionally, the media processing task 200 may be configured such that data flows from the second source node 204 to the destination node 226 via a preamp node 208, a third filter node 212, the filter gain node 220, and the compressor node 224. In parallel, the media processing task 200 may be configured such that data flows from the second source node 204 to the destination node 226 via the preamp node 208, a second gain node 216, the reverb node 218, the reverb gain node 222, and the compressor node 224.

An example of an abstract MCL file and associated syntax for the media processing task 200 is shown in Table 1. In an embodiment, an abstract MCL file may comprise an abstract resources data portion and a process data portion within a name space, for example, an extensible mark-up language name space (XMLNS). The abstract resources data portion comprises one or more unbound abstract resources each having one or more input constraints and/or one or more output constraints. An abstract resource may be a variable, label, or the-like associated with a device having a desired functionality (e.g., a node in a directed graph), as will be disclosed herein. In an embodiment, a constraint may be expressed using a conventional constraint language, for example, web real-time communications (WebRTC) media constraints. Alternatively, a constraint may be expressed using a machine-readable standard language, for example, English words. Additionally, the process data portion may define the data communication flow between the abstract resources. For example, the abstract MCL file may employ tags (e.g., processing tags, synchronization tags, etc.) to define the relationship between one or more abstract resources, such as, a join tag, a fork tag, and a pipe tag. In an embodiment, the join tag may define the joining of a plurality of data streams into a single data stream. The fork tag may describe the separation of one data stream into a plurality of data streams. The pipe tag may describe passing a data stream from a first resource (e.g., a first abstract resource) to a second resource (e.g., a second abstract resource). Additionally, the abstract MCL file may employ conventional tags. For example, the abstract MCL file may employ synchronized multimedia integration language (SMIL) tags, such as, parallel, sequential, exclusive, etc., to define execution of one or more abstract resource tasks. Additionally or alternatively, the abstract MCL file may employ any other tags or extensions to define the relationship between one or more abstract resources and/or to define execution of one or more abstract resource tasks, as would be appreciated by one of ordinary skill in the art upon viewing this disclosure.

For example, the resources data portion (e.g., shown as <resources>) comprises each of the nodes (e.g., the first source node 202, the second source node 204, the first filter node 206, etc.) of the directed graph as a resource element or constraint (e.g., shown as <resource>). Additionally, each resource element may comprise a resource identification associated with each node or abstract resource. A directed graph may be encoded as a MCL file (e.g., an abstract MCL file) employing a depth-first traversal using processing tags. As such, the process data portion (e.g., shown as <process>) comprises processing tags (e.g., pipe, join, fork, etc.) to define each data flow path and/or data communication path between each node of the directed graph as a process element.

TABLE 1
An example of an abstract MCL for media processing task 200

```
  <mc xmlns=“http://www.huawei.com/mc”>
  <resources>
```

<resource id=SOURCE1>...</resource>
<resource id=SOURCE2>...</resource>
...
<resource id=D>...</resource>

```
  </resources>
  <process>
```

<par>
<pipe>SOURCE1 FILTER

```
<fork>
  <pipe> F1 <join id=1/> FILTER_GAIN <join id=2/>
  COMPRESSOR DESTINATION
```

</pipe>

```
  <pipe> G1 <join id=3/> REVERB REVERB_GAIN <join
  id=2/>
</fork>
...
```

</par>

</process>
</mc>

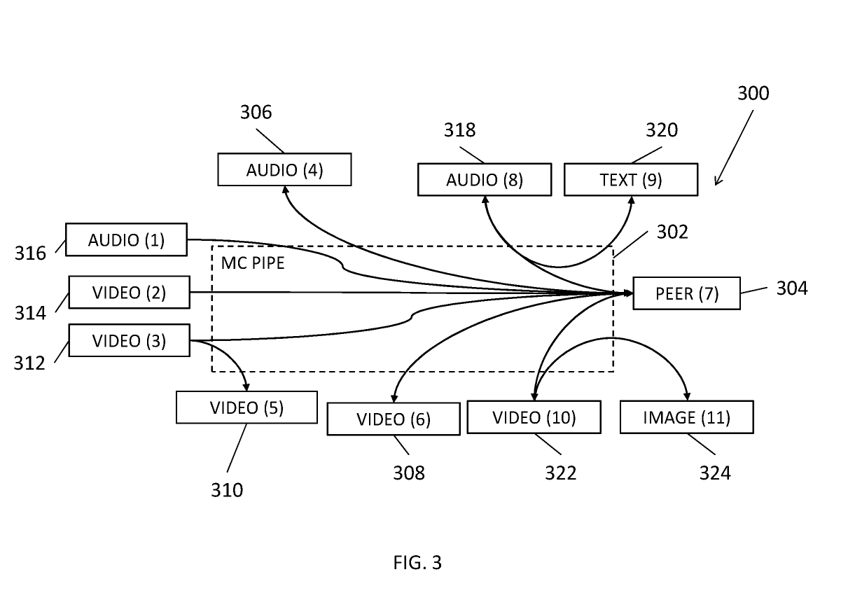

FIG. 3 is a schematic view of an embodiment of another media processing task 300. In such an example, the media processing task 300 is configured to provide a real-time media stream via a WebRTC call using automated speech recognition (ASR) and automated face recognition (AFR). In the embodiment of FIG. 3, the media processing task 300 comprises a plurality of resources in data communication with each other via a MC pipeline 302, which may be described in an abstract MCL file. For example, a peer 304 is configured to output data to an audio out 306, a video out 308, an audio out 318, and a video out 322. The audio out 318 is also configured to output data to a text out 320 and, thereby provide ASR. The video out 322 is also configured to output data to an image out 324 and, thereby provide AFR. Additionally, the peer 304 is configured to receive data from an audio in 316, a video in 314, and a video in 312. Further, the video in 312 is also configured to output data to a video out 310. An example of an abstract MCL file for the media processing task 300 is shown in Table 2.

TABLE 2
An example of an abstract MCL for media processing task 300

<mc xmlns=“http://www.huawei.com/mc”>
<resources>

<resource id=8>...</resource>
<resource id=9>...</resource>

...

```
  </resources>
  <process>
```

```
<par>
  <pipe> 7 <fork> 4 <pipe> 8 9 </pipe> </fork> </pipe>
  <pipe> 7 <fork> 6 <pipe> 10 11 </pipe> <fork> </pipe>
  ...
</par>
```

</process>
</mc>

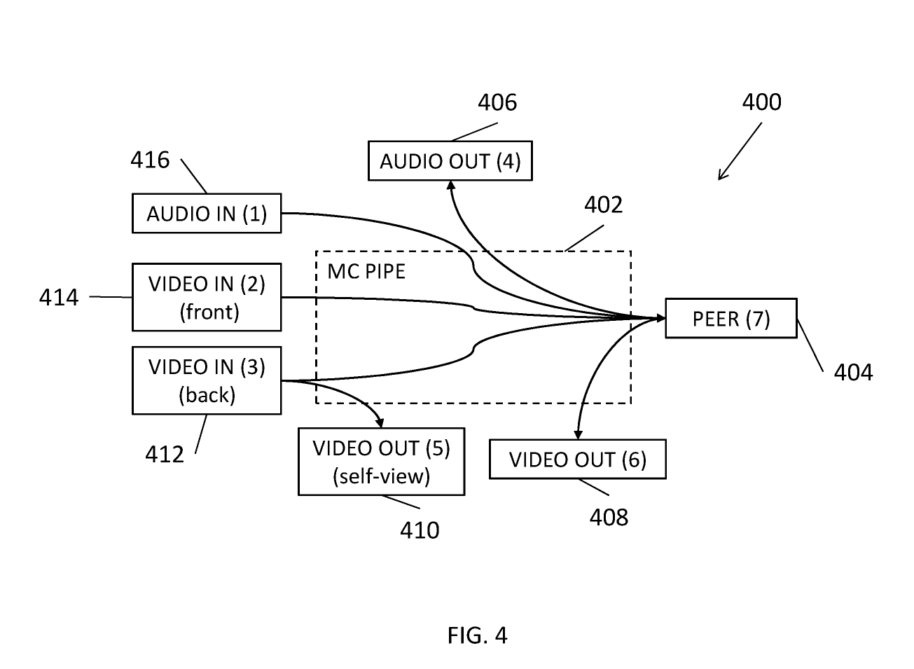

FIG. 4 is a schematic view of an embodiment of another media processing task 400. In such an example, the media processing task 400 is configured to provide a real-time media stream via a webRTC call using two cameras. In the embodiment of FIG. 4, the media processing task 400 comprises a plurality of resources in data communication with each other via a MC pipeline 402, which may be described in an abstract MCL file. For example, a peer 404 is configured to output data to an audio out 406 and to a video out 408. Additionally, the peer 404 is configured to receive data from an audio in 416, a video in 414, and a video in 412. Further, the video in 412 is also configured to output data to a video out 410. An example of an abstract MCL file for the media processing task 400 is shown in Table 3.

TABLE 3
An example of an abstract MCL for media processing task 400

<mc xmlns=“http://www.huawei.com/mc”>

<resources>

<resource id=1> audio in </resource>
<resource id=2> video in front </resource>
<resource id=3> video in back </resource>
...
<resource id=7> peer </resource>

</resources>
<process>

<par>

<pipe> 7 4 </pipe>
<pipe> 1 7 </pipe>
<pipe> 2 7 </pipe>
<pipe> 3 <fork> 7 5 </fork> </pipe>
<pipe> 7 6 </pipe>

</par>

</process>

</mc>

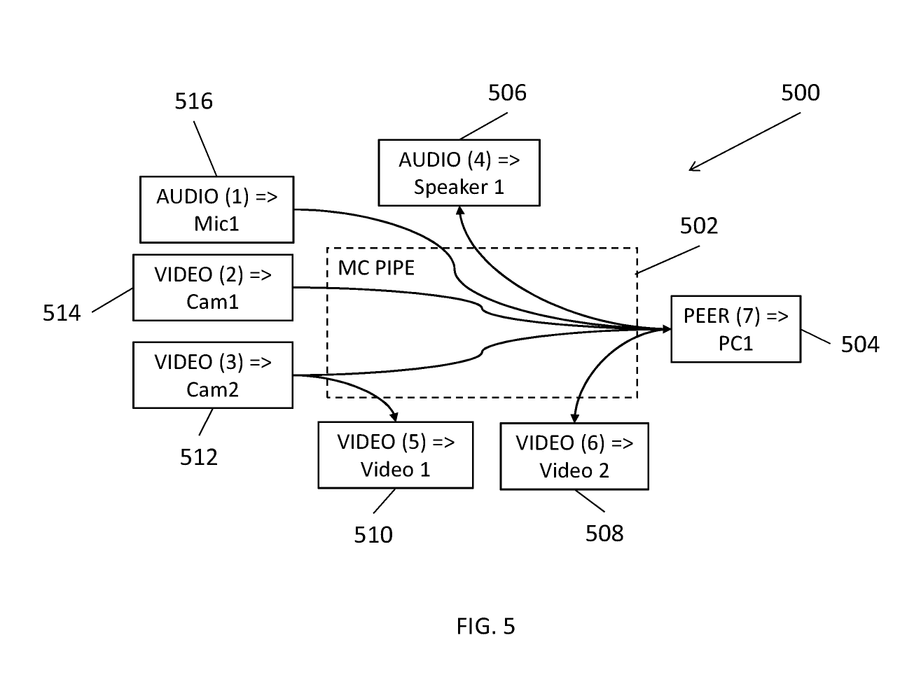

FIG. 5 is a schematic view of an embodiment of another media processing task 500. In such an example, the media processing task 500 may be configured similar to the media processing task 400, as shown in FIG. 4. Additionally, the media processing task 500 comprises concrete resources (e.g., mic 1, cam 1, cam 2, etc.) associated with each abstract resource. For example, a concrete resource may be a camera, a microphone, a speaker, a display, a HTML element, a mixer, a filter, an ASR, an AFR, a C++ object, a JS object, a peer connections session, a HTML5 object, a web resource on a server, or any other suitable media element (e.g., a media data source and/or sink) as would be appreciated by one of ordinary skill in the art upon viewing this disclosure.

An example of a concrete MCL file for the media processing task 500 is shown in Table 4. In an embodiment, a concrete MCL file may be generated and/or derived from an abstract MCL and may comprise no unbound abstract resources, as will be disclosed herein. The concrete MCL file comprises the abstract resources data portion and the process data portion each derived (e.g., copied) from an abstract MCL file. Additionally, the concrete MCL file comprises a binding data portion. The binding data portion binds or links each abstract resource to a concrete or physical resource (e.g., a speaker, a microphone, a camera, etc.). For example, a concrete resource may meet the constraints (e.g., input constraints and/or output constraints) of an abstract resource to be bound to the abstract resource.

In such an embodiment, the resources data portion (e.g., shown as <resources>) comprises each of the abstract resources as a resource element or constraint (e.g., shown as <resource>). Additionally, each resource element may comprise a resource identification associated with each node or abstract resource. The process data portion (e.g., shown as <process>) comprises processing tags (e.g., pipe, join, fork, etc.) to define each data flow path and/or data communication path between each abstract resource as a process element. The binding data portion (e.g., shown as <binding>) comprises each abstract resource element bound to a concrete resource (e.g., shown as <bind>).

TABLE 4
An example of a concrete MCL for media processing task 500

<mc xmlns=“http://www.huawei.com/mc”>

<resources>

<resource id=1> audio in </resource>
<resource id=2> video in front </resource>
<resource id=3> video in back </resource>
...
<resource id=7> peer </resource>

</resources>

<binding>

```
  <bind id=1> mic1 </bind>
  <bind id=2> cam1 </bind>
```

...

</binding>
<process>

<par>

<pipe> 7 4 </pipe>

<pipe> 1 7 </pipe>

<pipe> 2 7 </pipe>
<pipe> 3 <fork> 7 5 </fork> </pipe>
<pipe> 7 6 </pipe>

</par>

</process>

</mc>

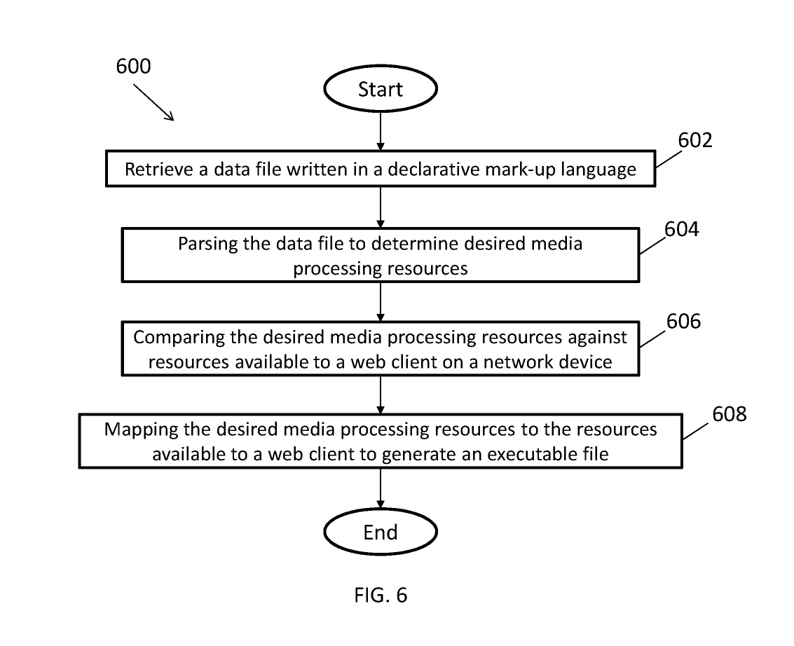

FIG. 6 is an embodiment of a media processing method 600. In block 602, a web client may retrieve a data file written in a declarative mark-up language. For example, a web client (e.g., web client 104 of FIG. 1) of a network device may download or receive a data file (e.g., an abstract MCL) from a web server (e.g., web server 102 of FIG. 1). In such an example, the abstract MCL comprises one or more abstract resources (i.e., desired media processing resources) for providing a communication session. In block 604, the web client may parse the data file to determine the desired media processing resources. For example, the abstract MCL may be received by a MC framework (e.g., MC framework 110 of FIG. 1) within the web client and may be parsed to determine the abstract resources desired for providing a communication session. In block 606, the desired media processing resources may be compared against the resources available to the web client. For example, a binding module (e.g., binding module 114 of FIG. 1) of the MC framework may compare the constraints (i.e., the input constraints and the output constraints) of the abstract resources to the parameters or capabilities of the resources available to the web client and/or network device (e.g., concrete resources), for example, a list or database of available resources and/or hardware, such as, a camera, a microphone, a speaker, a display, a HTML element, a mixer, a filter, an ASR, an AFR, a C++ object, a JS object, a peer connections session, a HTML5 object, or a web resource on a server. In block 608, the desired media processing resources may be mapped to the resources available to the web client to generate an executable file. For example, each of the abstract resources may be associated or mapped to a corresponding concrete resource available to the web client and/or network device to generate an executable file (e.g., a concrete MCL). In an embodiment, mapping an abstract resource to a concrete resource may require a signal indicating consent, such as, an acknowledgment, a selection, or a confirmation, for example, from a user. For example, the web client may request (e.g., prompt a user) for consent to use a concrete resource and may receive a signal indicating consent (e.g., a user's confirmation or selection) in response to the request. The executable file may comprise a description or instructions for implementing a communication session on the web client via the concrete resources. The concrete MCL may be executed by the web client (e.g., via an execution module, such as, execution module 118 of FIG. 1) to initiate the communication session. For example, the communication session may be implemented (e.g., displayed) via a web application (e.g., web application 106 of FIG. 1) and/or JS API (e.g., JS API 108 of FIG. 1) by the web client.

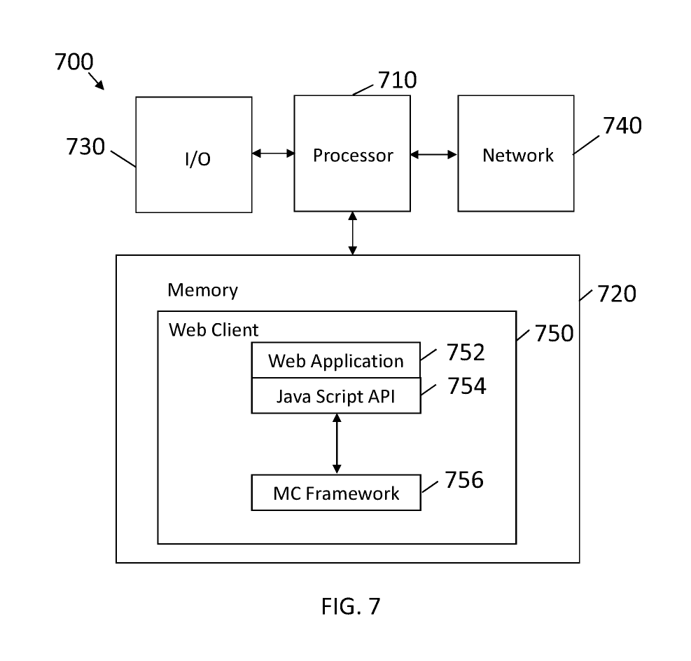

FIG. 7 illustrates a schematic view of an embodiment of a computer system or network client 700, which may be suitable for implementing one or more embodiments of the components or modules disclosed herein, such as the MC framework 110 as described in FIG. 1. The network client 700 includes a processor 710 that is in communication with memory 720, input/output (I/O) devices 730, and network device 740. Although illustrated as a single processor, the processor 710 is not so limited and may comprise multiple processors. The processor 710 may be implemented as one or more central processor unit (CPU) chips, cores (e.g., a multi-core processor), field-programmable gate arrays (FPGAs), application specific integrated circuits (ASICs), and/or digital signal processors (DSPs). The processor 710 may be configured to implement any of the schemes described herein, including the methods for binding and/or executing media resources, such as, media processing method 600. The processor 710 may be implemented using hardware or a combination of hardware and software.

The memory 720 may comprise secondary storage, random access memory (RAM), read-only memory (ROM), or any combination thereof. Secondary storage may comprise one or more disk drives or tape drives and is used for non-volatile storage of data and as an over-flow data storage device if the RAM is not large enough to hold all working data. The secondary storage may be used to store programs that are loaded into the RAM when such programs are selected for execution. The ROM may be used to store instructions and perhaps data that are read during program execution. The ROM may be a non-volatile memory device that typically has a small memory capacity relative to the larger memory capacity of the secondary storage. The RAM is used to store volatile data and perhaps to store instructions. Access to both the ROM and the RAM is typically faster than to the secondary storage.

The network device 740 (sometimes referred to as a transceiver) may serve as an output and/or input device of the network node. For example, if the network device 740 is acting as a transmitter, it may transmit data out of the network node. If the network device 740 is acting as a receiver, it may receive data into the network node. Further, the network device 740 may include one or more optical transmitters, one or more optical receivers, one or more electrical transmitters, and/or one or more electrical receivers. The network device 740 may take the form of modems, modem banks, Ethernet cards, universal serial bus (USB) interface cards, serial interfaces, token ring cards, fiber distributed data interface (FDDI) cards, and/or other well-known network devices. The network device 740 may enable the processor 710 to communicate with an Internet or one or more intranets. The messages described herein may be transmitted or received by the network device 740.

The I/O devices 730 may be optional or may be detachable from the rest of the system 700. The I/O devices 730 may include a video monitor, liquid crystal display (LCD), touch screen display, or other type of display. The I/O devices 730 may also include one or more keyboards, mice, or track balls, or other well-known input devices.

It is understood that by programming and/or loading executable instructions onto the system 700, at least one of the processor 710 or the memory 720 are changed, transforming the system 700 in part into a particular machine or apparatus, e.g., a web client 750 comprising a web application 752, a java script API 754, and a MC framework 756, having the functionality taught by the present disclosure. The web client 750 may, for example, may be the same as web client 504 shown in FIG. 5. Messages received by the network device 740 may be acquired by the web client 750. The executable instructions may be stored on the memory 720 for execution. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an ASIC, because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner, as a machine controlled by a new ASIC is a particular machine or apparatus, likewise a computer that has been programmed and/or loaded with executable instructions may be viewed as a particular machine or apparatus.

Any processing of the present disclosure may be implemented by causing the processor, such as processor 710, to execute a computer program. In this case, a computer program product can be provided to a network client, such as network client 700, using any type of non-transitory computer readable media, such as memory 720. The computer program product may be stored in a non-transitory computer readable medium in the computer or the network device. Non-transitory computer readable media include any type of tangible storage media. Examples of non-transitory computer readable media includes magnetic storage media (such as floppy disks, magnetic tapes, hard disk drives, etc.), optical magnetic storage media (e.g. magneto-optical disks), compact disc ROM (CD-ROM), compact disc recordable (CD-R), compact disc rewritable (CD-R/W), digital versatile disc (DVD), Blu-ray (registered trademark) disc (BD), and semiconductor memories (such as mask ROM, programmable ROM (PROM), erasable PROM, flash ROM, and RAM). The computer program product may also be provided to a computer or a network device using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

In an embodiment, a MC framework, such as MC framework 110 of FIG. 1, a system comprising such a MC framework, and/or a binding and/or execution method, as disclosed herein or in some portion thereof, may be advantageously employed to provide real-time media using one or more media resources. Conventional systems may employ different java script APIs which may follow different design patterns and programming models and, thereby may make it more difficult for developers to use. A MC framework employs a uniform programming model and language (e.g., MCL), which may provide increased performance during searches and analysis by a machine and/or developers. Conventional systems may be configured to employ multiple functions lacking a common API which may require adding more abstraction (e.g., jquery), and thereby increasing code size and complexity. The MC framework enables different resources to interoperate within a uniform framework without a bilateral agreement on API. Conventional systems may require changes to existing standard APIs to introduce new functions or functionality. A MC framework may not require changing the framework or other collaborative resources when introducing new resources. The performance and optimization of a conventional system may vary based on a web developer's design. Employing a MC framework enables a web browser to optimize performance based on a developer's and/or user's specifications. Conventional systems employing java script may be vulnerable to security holes since the system behavior is unknown until execution. A MC framework enables a web client to determine media resources prior to execution. In a conventional system, java script may be more difficult to search, compare, analyze, and/or compose with other web languages with a machine. A MC framework may be searched, analyzed, linked, or embedded into a variety of host languages by machines.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations may be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R₁, and an upper limit, Rᵤ, is disclosed, any number falling within the range is specifically disclosed. In particular, the following numbers within the range are specifically disclosed: R=R₁+k*(Rᵤ−R₁), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. The use of the term “about” means+/−10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having may be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. In a web client in a network device, a method comprising:
retrieving a data file written in a declarative mark-up language, wherein the data file contains a description of desired media processing resources for providing a communication session;
parsing the data file to determine the desired media processing resources;
comparing the desired media processing resources against resources available to the web client on the network device; and
mapping the desired media processing resources to the resources available to the web client to generate an executable file, wherein the executable file contains a description for implementing the communication session via the resources available to the web client.

2. The method of claim 1, wherein each of the desired media processing resources comprises a type of resource and a constraint associated with the type of resource, and wherein the comparing comprises comparing the types of resources and their associated constraints against resources available to the web client on the network device.

3. The method of claim 1, further comprising executing the executable file to provide the communication session.

4. The method of claim 3, further comprising requesting consent for use of a resource available to the web client and receiving a signal indicating consent in response to the request.

5. The method of claim 4, wherein mapping the desired media processing resources to the resources available to the web client to generate an executable file is based on the signal indicating consent.

6. The method of claim 1, wherein the data file comprises:
an abstract resources data portion, wherein the abstract resources data portion describes the desired media processing resources and associated constraints for providing a communication session; and
a process data portion, wherein the process data portion describes data communication flow between the desired media processing resources.

7. The method of claim 1, wherein the executable file comprises:
an abstract resources data portion, wherein the abstract resources data portion describes the desired media processing resources and associated constraints for providing a communication session;
a binding data portion, wherein the binding data portion describes the mapping of the desired media processing resources to the resources available to the web client; and
a process data portion, wherein the process data portion describes data communication flow between the desired media processing resources.

8. A computer program product comprising computer executable instructions stored on a non-transitory medium that when executed by a processor cause a web client in a network device to perform the following:
retrieve a data file written in a declarative mark-up language from a memory device, wherein the data file contains a description of desired media processing resources for providing a communication session;
parse the data file to determine the desired media processing resources;
compare the desired media processing resources against resources available to the web client; and
map the desired media processing resources to the resources available to the web client to generate an executable file, wherein the executable file contains a description for implementing the communication session via the resources available to the web client.

9. The computer program product of claim 8, further comprising instructions causing the web client to execute the executable file to provide the communication session.

10. The computer program product of claim 9, further comprising instructions to cause the web client to request consent for use of a resource available to the web client and receive a signal indicating consent in response to the request.

11. The computer program product of claim 10, wherein mapping the desired media processing resources to the resources available to the web client to generate the executable file is based on the signal indicating consent.

12. The computer program product of claim 8, wherein each of the desired media processing resources comprises a type of resource and a constraint associated with the type of resource, and wherein the comparing comprises comparing the types of resources and their associated constraints against resources available to the web client on the network device.

13. The computer program product of claim 8, wherein the data file comprises:
an abstract resources data portion, wherein the abstract resources data portion describes the desired media processing resources and associated constraints for providing a communication session; and
a process data portion, wherein the process portion describes data communication flow between the desired media processing resources.

14. The computer program product of claim 8, wherein the executable file comprises:
an abstract resources data portion, wherein the abstract resources data portion describes the desired media processing resources and associated constraints for providing a communication session;
a binding data portion, wherein the binding data portion describes the mapping of the desired media processing resources to the resources available to the web client; and
a process data portion, wherein the process portion describes data communication flow between the desired media processing resources.

15. An apparatus comprising:
a processor;
a memory in data communication with the processor, wherein the memory device comprises computer executable instructions that when executed by the processor causes the apparatus to perform the following:
retrieve a data file written in a declarative mark-up language, wherein the data file contains a description of desired media processing resources for providing a communication session;
parse the data file to determine the desired media processing resources;
compare the desired media processing resources against resources available to a web client; and
map the desired media processing resources to the resources available to the web client to generate an executable file, wherein the executable file contains a description for implementing the communication session via the resources available to the web client.

16. The apparatus of claim 15, further comprising instructions to execute the executable file to provide the communication session.

17. The apparatus of claim 16, further comprising instructions requesting consent for use of a resource available to the web client and receiving an indication of consent in response to the request.

18. The apparatus of claim 15, wherein each of the desired media processing resources comprises a type of resource and a constraint associated with the type of resource, and wherein the comparing comprises comparing the types of resources and their associated constraints against resources available to the web client.

19. The apparatus of claim 15, wherein the data file comprises:
an abstract resources data portion, wherein the abstract resources data portion describes the desired media processing resources and associated constraints for providing a communication session; and
a process data portion, wherein the process data portion describes data communication flow between the desired media processing resources.

20. The apparatus of claim 15, wherein the executable file comprises:
an abstract resources data portion, wherein the abstract resources data portion describes the desired media processing resources and associated constraints for providing a communication session;
a binding data portion, wherein the binding data portion describes the mapping of the desired media processing resources to the resources available to the web client; and
a process data portion, wherein the process data portion describes data communication flow between the desired media processing resources.
